(19) United States
(12) Patent Application Publication
(10) Pub. No.: US 2006/0047939 A1
(43) Pub. Date: Mar. 2, 2006

(54) METHOD AND APPARATUS FOR INITIALIZING MULTIPLE PROCESSORS RESIDING IN AN INTEGRATED CIRCUIT

(75) Inventors: Robert J. Devins, Essex Junction, VT (US); Paul G. Ferro, South Burlington, VT (US); David W. Milton, Underhill, VT (US); Arnold S. Tran, South Burlington, VT (US)

Correspondence Address: IBM MICROELECTRONICS;INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, NY (US)

(21) Appl. No.: 10/711,204

(22) Filed: Sep. 1, 2004

(51) Int. Cl. G06F 9/24

(52) U.S. Cl. 713/2

(57) ABSTRACT

A method and apparatus for initializing multiple processors in an integrated circuit. Each processor is uniquely identifiable. Boot code for the initialization of the processors is written so that any specialized code for a specific processor is accessed using identity of the processor.

### DESCRIPTION

1. Field of the Present Invention

The present invention generally relates to integrated circuits, and more specifically, to integrated circuits having multiple processors that are to be initialized during the powering on of the integrated circuit.

2. Description of Related Art

Consumers continuously challenge the electronic industry to produce increasingly smaller devices while introducing even greater functionality. It has become an expectation of the consumer that these devices will become instantly available upon turning the power on.

These devices typically contain a myriad of integrated circuits each supporting numerous functional capabilities with the assistance of one or more processors. The initialization of these processors has been accomplished using several different solutions. The previous solutions were developed without the time constraints presented by the current instantaneous expectations of the consumer.

It would, therefore, be a distinct advantage to have a method and system that would initialize multiple processors residing in an integrated circuit in a time and code efficient manner. The present invention provides such a method and apparatus.

### SUMMARY OF THE PRESENT INVENTION

The present invention initializes multiple processors in an integrated circuit. Boot code is written for initialization of the processors so that there is a general/common section and specific sections for processor specific code. Each one of the processors is uniquely identifiable (in the preferred embodiment of the present invention, the strapping of a unique value to a register is used). During execution of the general section of boot code, the identity of the processor is used to execute any specific code for the identified processor in the specific section of boot code.

### BRIEF DESCRIPTION OF THE DRAWINGS

The present invention will become better understood and its numerous advantages will become more apparent to those skilled in the relevant art by reference to the following drawings, in conjunction with the accompanying specification, in which:

FIG. 1 is a block diagram illustrating an integrated circuit 102 having multiple processors P1-Pn that are initialized according to the teachings of the present invention; and

FIG. 2, a flow chart is shown illustrating the method for initializing the processors P1-Pn of FIG. 1 according to the teachings of the present invention.

### DETAILED DESCRIPTION OF THE PREFERRED EMBODIMENT OF THE PRESENT INVENTION

The present invention initializes multiple processors, residing in an integrated circuit, by providing each processor with a unique identification value. This unique identification value is then used by the boot code to identify specific code to initialize the identified processor. The incorporation of the identity of the processor into the boot code allows each of the processors to contain the same address for the boot code (i.e. starting point), and to reuse common portions of the boot code as explained in greater detail below in connection with the corresponding figures.

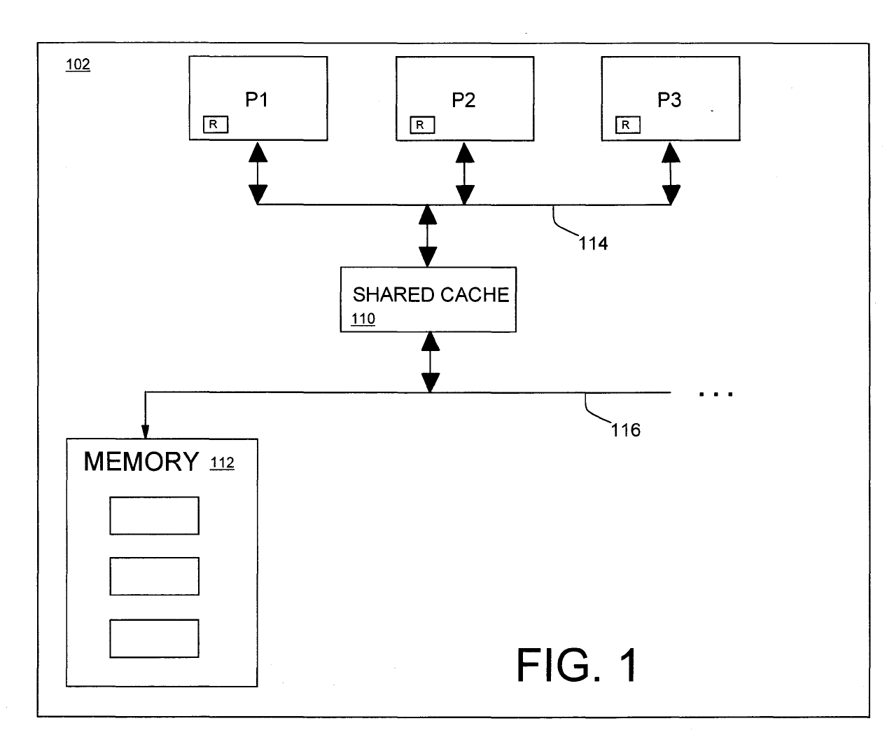

Reference now being made to FIG. 1, a block diagram is shown illustrating an integrated circuit 102 having multiple processors P1-Pn that are initialized according to the teachings of the present invention. Integrated circuit 102 includes multiple processors P1-Pn, a shared cache 110, memory 112, processor bus 114, and system bus 116.

The processors P1-Pn can be, for example, the PowerPC 405 processor from International Business Machines or any other processor capable of being incorporated into an integrated circuit. In the preferred embodiment of the present invention, each of the processors P1-Pn include a register that is strapped or otherwise provided with a value to uniquely identify the processor P1-Pn. Each one of the processors P1-Pn is provided with the capability of transferring and receiving data via processor bus 114.

Shared Cache 110 is a standard shared cache implementation having sufficient size and speed to accommodate the aspects of the present invention as explained in greater detail with the other elements of integrated circuit 102. It should be noted, however, that shared cache 110 is optional and not a necessary requirement for the present invention, but merely enhances the speed and operation of the present invention where such speed and operation are desirable (e.g. large number of processors). Shared Cache 110 is coupled to the processor bus 114 and the system bus 116.

Shared memory 112 is a typical memory having a sufficient size to store the boot code for the processors P1-Pn, and is coupled to system bus 116. The boot code should be located at an address that is consistent with the address provided to the processors P1-Pn for initialization. A pseudo code example of the boot code is provided in Table 1 below.

TABLE 1
// General Initialization Code//

perform code routines here that are common for all processors.
Read unique identification value of processor
Jump/branch to processor specific code as identified by
unique identifier

//Processor Specific Code //

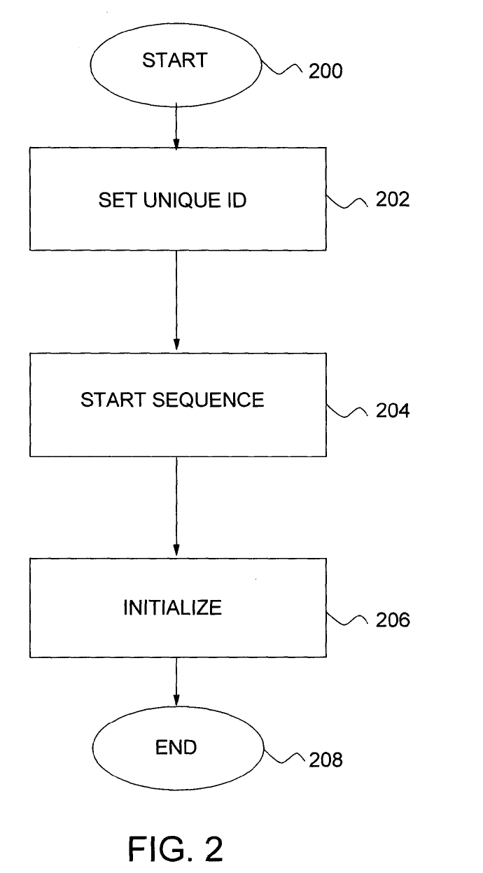

Reference now being made to FIG. 2, a flow chart is shown illustrating the method for initializing the processors P1-Pn of FIG. 1 according to the teachings of the present invention. The method begins (step 200) by providing each one the processors P1-Pn with a unique identification (step 202). In the preferred embodiment of the present invention, the unique identification is provided by strapping a register, such as a DCR register. The method continues by executing a particular start sequence for the processors P1-Pn (step 204) where each of the processors P1-Pn executes the boot code residing either in memory 112 or shared cache 110 (if retrieved by a previous processor P1-Pn) (step 204). The unique identification is used in the boot code to initialize the processor P1-Pn with any processor P1-Pn specific code.

What is claimed is:

1. A method of initializing a plurality of processors in an integrated circuit, the method comprising the steps of:
identifying each one of the processors;
executing boot code for initializing each one of the processors, the boot code containing specific code for at least one of the processors and common code that is common for each one of the processors, the specific code being accessed according to the identity of the processor executing the boot code.

2. The method of claim 1 wherein the step of identifying includes the step of:
assigning a unique value to each one of the processors.

3. The method of claim 2 wherein each one of the processors includes a register and the step of assigning includes the step of:
providing a unique value to the register of the processor.

4. An apparatus for initializing a plurality of processors in an integrated circuit, the apparatus comprising:
means for identifying each one of the processors;
means for executing boot code for initializing each one of the processors, the boot code containing specific code for at least one of the processors and common code that is common for each one of the processors, the specific code being accessed according to the identity of the processor executing the boot code.

5. The apparatus of claim 4 wherein the means for identifying includes:
means for assigning a unique value to each one of the processors.

6. The apparatus of claim 5 wherein each one of the processors includes a register and the means for assigning includes:
means for providing a unique value to the register of the processor.

7. An integrated circuit comprising:
a plurality of processors each having a unique identifier;
a bus for providing data to and from each one of the processors;
a memory, coupled to the bus, having boot code for initializing each one of the processors, the boot code using the unique identifier of each processor to access code that is unique to the identified processor.

8. The integrated circuit of claim 7 wherein each one of the processors has at least one register, and the at least one register is used to store a unique identifier.

9. The integrated circuit of claim 7 further comprising a cache shared between the plurality of processors.

10. A method of initializing multiple processors in an integrated circuit, the method comprising the steps of:
creating boot code for initializing the processors, the boot code having code that is common for each one of the processors, and code that is specific for each one of the processors;
assigning each one of the processors a unique identifier; and
executing the boot code and accessing code that is specific for a processor using the unique identifier of the processor.

11. The method of claim 10 wherein the step of assigning includes the step of:
storing a unique value into a register of each one of the processors.
